(19) United States
(12) Patent Application Publication
(10) Pub. No.: US 2008/0151683 A1
(43) Pub. Date: Jun. 26, 2008

(54) Stir-bag system with stand and turbulence member

(76) Inventors: Charles Meadows, Glenmoore, PA (US); Jay R. Harp, Conshohocken, PA (US); Michael A. Ryan, Norristown, PA (US); Steven Welch, Phoenixville, PA (US)

Correspondence Address: Robert R. Axenfeld;Montgomery, McCracken, Walker & Rhoads, 123 South Broad Street, Philadelphia, PA, 19109, US

(21) Appl. No.: 11/985,328

(22) Filed: Nov. 14, 2007

Related U.S. Application Data
(60) Provisional application No. 60/859,012, filed on Nov. 14, 2006.

(51) Int. Cl. B01F 13/08; B01F 15/06; F16M 1/04

(52) U.S. Cl. 366/145; 366/273; 248/676

(57) ABSTRACT

A flexible container is used in conjunction with a magnetic mixer. The flexible container is in the form of a bag, and is designed to rest on top of a magnetic mixer. The bag is comprised of a flexible, but impermeable-film material. A stand may be used in conjunction with bag to support larger volume flexible containers when filled with solution, permitting the exterior body of the flexible container to rest against the sides of the stand. A baffle may be interposed between the stand and bag. The baffle contacts, and thereby deforms (indents) the flexible film membrane of the container, when the container is filled with solution. So, when a stir bar of the mixer spins and fluid circulates, the baffle causes fluid to circulate erratically around a protrusion caused by the baffle, and imparts turbulence when fluid mixes around it. This prevents backflow from occurring.

### CROSS-REFERENCE TO RELATED APPLICATIONS

The present patent application claims benefit of U.S. Provisional Application Ser. No. 60/859,012 filed on 14 Nov. 2006. The present patent application also relates to commonly assigned U.S. application Ser. No. ______, entitled “Mixing Bag for Use with Nonabrasive Stir Bar,” filed 14 Nov. 2007.

### TECHNICAL FIELD

The present invention relates generally to sanitary mixing systems, and more specifically, to mixing systems that use a magnetic mixing bar for stirring fluid.

### BACKGROUND

Pharmaceutical and biotechnology companies often mix their fluid-based solutions in a sterile and sealed environment to ensure their products are pure and safe for their intended use.

One system presently used to mix fluids is a magnetic-mixing-bar system, which includes a magnetic-mixing bar (“stir bar”) disposed in a container. The container rests upon a magnetic mixer. When the magnetic mixer is activated, a magnetic force is emitted by the mixer, which causes the stir bar in the container to spin, thereby mixing and/or suspending a solution. The mixer is able to control the speed and variability at which the stir bar rotates in the container.

The container used to hold the solution is often made of glass, or a rigid material, such as hard plastic. In a rigid form, containers are costly to ship, and store. The containers are also prone to accidental breaking; especially when made of glass.

Additionally, when the container is made of glass, the container must be sterilized. After a single mixing session, many companies dispose of the glass containers, rather than clean them for re-use, which is wasteful, and further increases costs.

Connecting hoses and tubing to a rigid glass or plastic container is often time consuming and difficult, especially when attempting to ensure a sterile and a sealed connection.

Still another drawback of magnetic-mixing systems involves what is known backflow. this is a phenomenon where all the fluid moves in unison without creating turbulence in the container. So, mixing of constituent elements of a solution does not occur in a timely manner, or at all.

### SUMMARY

To solve these and other problems, this invention introduces the concept of using a flexible container in conjunction with a magnetic mixer, and a stir bar. The flexible container is in the form of a bag, and is designed to rest on top of a magnetic mixer. The bag is comprised of a flexible, but impermeable-film material, such as polyethylene, PVDF (Polyvinylidene Difluoride), EVA (Ethylene Vinyl Acetate), nylon, Polypropylene, PVC, or other films. So, when the magnetic mixer is activated, a magnetic force is emitted by the mixer, which causes the stir bar in the bag to spin, thereby mixing and/or suspending a solution. The mixer is able to control the speed and variability at which the stir bar rotates in the bag. The bag is flat with no seams on the bottom to avoid interfering with rotation of the stir bar.

Further, in one embodiment, the stir bar is encapsulated in a nonabrasive, and soft material, such as silicone. The non-abrasive material around the stir bar permits the stir bar to directly touch the flexible film material, and prevents scratching or deteriorating of the film, as the stir bar rotates on the bottom of the flexible container.

In yet another embodiment, the stir bar is smoothed and/or molded to exclude a flashing. That is, roughness of the stir bar is smoothed, and/or the stir bar is molded to help reduce roughness or flashing. The non-abrasiveness of the stir bar, again, permits it to spin directly on the film material of the flexible container without scratching or deteriorating of the flexible container's material, as the stir bar rotates on the bottom of the flexible container.

In still another embodiment, a stand straddles the mixer system. The stand has four walls that are generally coextensive with outer peripheral edges of a top surface—i.e., the mixing surface—of the magnetic mixer. The stand forms an internal compartment in which the flexible container is placed when resting on top of the magnetic mixer. The stand may support larger volume flexible containers when filled with solution, permitting the exterior body of the flexible container to rest against the sides of the stand. The support of the flexible container helps to prevent a failure of the flexible container when filled with fluid. It is pointed out that the stand may be implemented with support structures other than walls, such as poles, rods, wires, and other structures, as would be appreciated by those skilled in the art having the benefit of this disclosure. Additionally, the stand does not necessarily have to straddle the mixer system, and may include less than four walls.

The stand may include one or more cut-out(s) or orifice(s) in its side, to permit a tube to extend from the bottom or side of the flexible container to conveniently dispense solutions from the container, while the container rests on top of the magnetic mixer. Additionally, the top of the stand may include one or more opening(s) also permitting easy access to the container, and the ability to connect hosing and tubes directly the container. Liquids and powders may, therefore, be easily dispensed into the container while the container rests on top of the magnetic mixer.

In another embodiment, the stand may emit heat or coolness. For instance, the stand may include an outer jacket area, in which heated or cooled fluid may be circulated. As the flexible bag fits-in and rests against the sides of the stand, stand can dynamically control the temperature of solutions while being mixed.

In still another embodiment, one or more baffles, or other support structures may be interposed between the sides of the film of the flexible container, and the inner sides of the stand. Each baffle, or other support structure, causes the container to deform when filled with fluid, because the flexible container takes the shape of the stand, or any rigid structures it abuts. Each baffle or support structure causes fluid to circulate erratically around the baffle or structure, and imparts turbulence when fluid mixes around it. This prevents backflow from occurring. It is pointed out that one or more baffles could also be integrated or installed as part of the container in other embodiments.

Thus, features and advantages of the invention include:
Disposability—Since each container is comprised of an inexpensive and flexible material in the form of a bag, it is possible to dispose of it after a single use, if desired.
Durability and safety—Flexible containers are more durable than glass or rigid containers. If for any reason a flexible container breaks while filled with solution, it does not present as dangerous a safety hazard as a glass container exploding.
Reduced costs—Since the flexible containers may be folded-up, and do not require rigid materials, they are less expensive to ship and store than rigid containers. Additionally, it is possible to autoclave multiple flexible containers (bags) at one time, rather than a single glass/rigid-bottle container at one time.
Improved efficiency of mixing—Use of baffles or rigid support structure(s) interposed between the flexible container and the rigid stand, prevent backflows—a phenomenon where all the fluid moves in unison without creating turbulence in the container.
Temperature regulation—The ability to control warmth or coolness of solutions, through a jacketed stand that fits over the mixer and possesses the flexible container.
Ease of evacuating liquid—The stand may include one or more cut-outs or orifices to facilitate tubing to extend from the bottom-side portions of a bag, such as for evacuation of fluid from the bag.
Sterilization of ancillary components in unison—Flexible containers can be autoclaved or sterilized with probes and measuring devices in the bag.

Additional features and advantages of the invention will be set forth in the description which follows, and, in part, will be apparent from the description, or may be learned by practice of the invention.

It is to be understood that both the foregoing, and the following detailed description are exemplary and explanatory, and are intended to provide further explanation of the invention as claimed. The detailed description, however, is not intended to limit the scope of the claimed invention.

### BRIEF DESCRIPTION OF THE DRAWINGS

The detailed description is explained with reference to the accompanying figures. In the figures, the left-most digit(s) of a reference number identifies the figure in which the reference number first appears. It is pointed out that the figures are not necessarily drawn to scale and are for illustration purposes only.

FIG. 1A shows one embodiment of a mixing system in which features of the present invention may be implemented.

FIG. 1B shows a top view of a three-dimensional container.

FIG. 2 shows a cross-sectional view of a stir bar encapsulated in a sheath comprised of a soft-material.

FIG. 3 shows another embodiment of a mixing system which includes a stand.

FIG. 4 shows a top view of another embodiment of a stand with a jacketed chamber.

FIG. 5 shows a top view of a stand with a baffle interposed between the flexible container (bag) and side walls of the stand. FIG. 5 also shows current flow of fluid in the bag when mixed by a stir bar when a baffle or other protruding structure abuts the bag.

### DETAILED DESCRIPTION

Reference herein to “one embodiment”, “an embodiment”, or similar formulations herein, means that a particular feature, structure, operation, or characteristic described in connection with the embodiment, is included in at least one embodiment of the present invention. Thus, the appearances of such phrases or formulations herein are not necessarily all referring to the same embodiment. Furthermore, various particular features, structures, operations, or characteristics may be combined in any suitable manner in one or more embodiments.

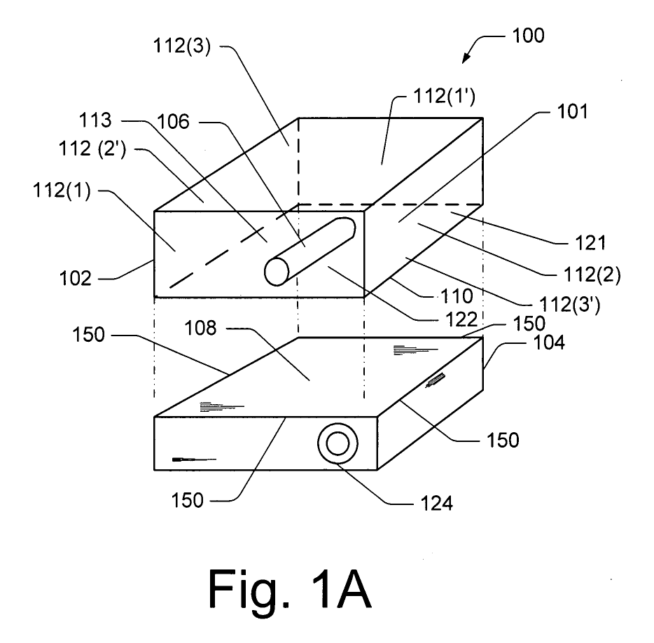

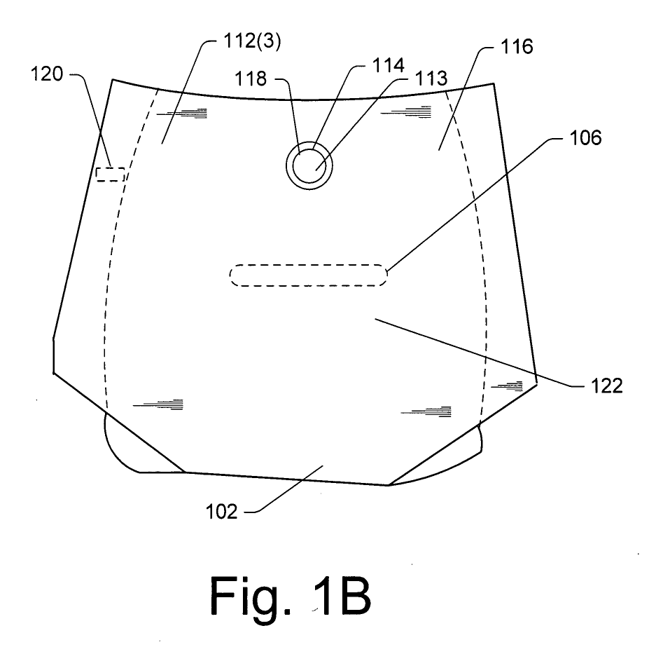

FIG. 1A shows one embodiment of a mixing system 100 in which features of the present invention may be implemented. In particular, FIG. 1A shows an exploded-perspective view of system 100. System 100 includes a flexible container 102, a magnetic mixer 104, and a stir bar 106 disposed within flexible container 102. Each shall now be described in greater detail as follows:

### Flexible Container

Flexible container 102 is a collapsible bag designed to fit, and rest on top of a magnetic mixer 104, such as a top surface 108 of mixer 104. In the illustration of FIG. 1A, container 102 is transparent, but could also be opaque (see FIG. 1B). In one embodiment, container 102 is generally square in shape to match the contours of plate 108. It is also possible for container 102 come in other shapes, and configurations, as would be appreciated by those skilled in the art after having the benefit of this detailed description. For example, container 102 may be cylindrical, rectangular, polygonal, and trapezoidal in shape.

Container 102 may be comprised of one or more sheets 112 of flexible film material, such as a polymeric material that is generally impermeable to liquids. Other materials may be selected for the film material as would be appreciated by those skilled in the art such as PVDF, Nylon, EVA, PVC, polypropylene and other suitable materials, including composites thereof.

As depicted in FIG. 1A, there is a front sheet 112(1), a rear sheet 112(1′), side sheets 112(2), 112(2′), a top sheet 112(3), and a bottom sheet 112(3′). Sheets 112 are secured together at their peripheries (i.e., edges) to form a sealed compartment 113 in which to mix fluid. Each sheet 112 may be secured together by an adhesive or through welding.

In other embodiments, sheets 112 of container 102 can also be formed through extrusion to form a two or three-dimensional sealed configuration. As appreciated by those skilled in the art, there are a variety of ways to form and seal container 102 to create a two-or-three dimensional bag that is completely collapsible when empty.

Each sheet 112 (flexible film) can also have varying thickness such as in relation to the volume of solution. In one embodiment, the thickness is generally about 0.012 inches thick. Generally, container 102 can be sterilized by conventional techniques such as irradiation. It is also possible to autoclave container 102 if made of a resilient material such as PVDF® resin.

Container 102 is designed with a flat, and seamless bottom 110, which allows stir bar 106 to rotate directly on bottom 110 of inner compartment 113, without having to levitate, and without any interference when spinning. Bottom 110 of container 102 is a content-base portion of container 102, and is usually positioned opposite the top of the bag, from which fluids and powders are typically dispensed via one or more ports (to be described) into the bag for mixing. Bottom sheet 112(3′) is configured to lie flat on top surface 108 of magnetic mixer 104. Additionally, bottom sheet 112(3′) is sealed at its periphery, and away from its center. As will become apparent to those skilled in the art, this feature permits stir bar 106 to rotate without inference from seams.

Container 102 may be sized to hold different amounts of fluid such as ten liters, 50 liters, 100 liters, or other amounts, larger or smaller. Thus, from the foregoing, and as would be appreciated by those skilled in the art, container 102 may be configured to virtually any desired size, and shape.

FIG. 1B shows a top view of a three-dimensional container 102. As depicted in FIG. 1B, container 102 may have one or more ports. For example, container 102 includes an input port 114 located on top 116 of container 102, and opposite the content-base portion (e.g., bottom 110 (see FIG. 1(A)) of container 102. Input port 114 includes a sealed hole 113 through sheet 112(3) of top 116 of container 102. Input port 114 allows materials to be delivered to an inside compartment 101 (FIG. 1A) of container 102 for mixing. A stem 118 may be coupled in a sealed manner (e.g., welded or other techniques) to port 114. Stem 118 permits hoses (not shown) or other components to be selectively attached to container 102 for delivering materials thereto for mixing in compartment 101 (FIG. 1A). It is appreciated by those skilled in the art after having the benefit of this disclosure that input port 114 may be located in other areas, such as on the side of container 102.

In one embodiment, container 102 may also include an output port 120 on side-bottom portion 121 (see FIG. 1A) of container 102, but away from a flat area 122 (FIG. 1A) of content-base portion 110 of container 102 where the stir bar 106 spins to avoid interfering with stir bar 106 when rotating inside container 102. Output port 120 (FIG. 1B) is generally used to dispense material out of container 102, and includes a hole (not shown) formed in a side sheet 112 of container 102.

It is appreciated by those skilled in the art, that additional ports can be formed in container 102. They may also be formed of any suitable size, such as corresponding to a type of material to be dispensed in or out of container 102. Further, the locations of each port can vary, and are not limited to the locations shown in the exemplary implementation of FIG. 1B.

When container 102 is implemented through the use of an ultra soft, non-abrasive stir rod 106, it is pointed out that the stir rod 106 automatically aligns itself in the center of top surface 108 of magnetic mixer 104. And container 102 does not require exact alignment with the center of top surface 108.

In another embodiment, a rigid surface (not shown) may be sealed to the bottom 110 of container 102 on which an off-the-shelf stir bar 106 may spin without damaging the flexible membrane film of container 102. The rigid surface could be implemented as a piece of glass or rigid piece of polyethylene, or a material similar to the construction of the film (e.g. one or more sheets 112). The rigid surface could take the form of a hard disc. The rigid surface is preferably heat sealed or welded to container 102 to avoid fluid from getting between the film membrane and the rigid surface. The rigid surface is not required, if stir rod 106 is implemented in a non-abrasive form in accordance with an embodiment of this invention, as described herein.

However, if container 102 contains a rigid surface, it is typically necessary to physically align the position the disc (the rigid surface) with center of top surface 108.

### Magnetic Mixer

As depicted in FIG. 1A, in one embodiment, magnetic mixer 104 is a standard off-the-shelf drive unit that uses magnetic energy to rotate stir bar 106 (to be described in greater detail). Examples of commercially available magnetic mixers include models from the Barnstead International of Dubuque, Iowa, USA. Typically, mixer 104 has a flat top surface 108 on which containers are placed for mixing, such as container 102. Suitable controls 124 may be located on the mixer 104 to adjust the speed and temperature of surface 108. Typically, magnetic mixer 104 controls speed at which stir bar 106 rotates.

### Stir Bar

Stir bar 106 is disposed within compartment 101 of container 102, and generally rotates when magnetic mixer 104 is activated. In one embodiment, stir bar 106 is a standard off-the-shelf magnetic-mixing bar that is encapsulated in an outer sheath of a soft material.

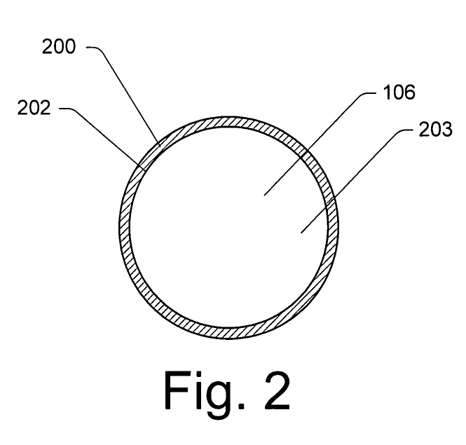

For example, FIG. 2 shows a cross-sectional view of stir bar 106 encapsulated in a sheath 200 comprised of a soft material. The soft material of sheath 200 prevents stir bar 106 from scratching or deteriorating the film material of container 102 when stir bar 106 rotates on bottom 110 of container 102 during operation.

Sheath 200 may cover an outer-most layer of the off-the-shelf stir bar 106, which is usually a Teflon® related material. Alternatively, sheath 200 may cover a core 203 of stir bar 106, and one or more other layers of materials covering the magnet (not shown) can be eliminated, as would be appreciate by those skilled in the art after having the benefit of this disclosure.

In one embodiment, when sheath 200 covers a standard off-the-shelf stir bar, sheath 200 is made from a silicone. In other embodiments, other suitable materials may be selected for use around stir bar 106 or core 203 such as, Nylon, PVC, thermoplastic elastomer, Teflon®, and composites.

In one embodiment, the thickness is generally less than a ¼ inch. In another embodiment, sheath 200 is approximately 1/32 inches thick. It is appreciated by those skilled in the art after having the benefit of this disclosure, however, that other suitable thickness—thicker or thinner—may be selected for sheath 200.

Sheath 200 may be molded around stir bar 106, such as through an extrusion dye process. Regardless of the process used, it is important that any abrasive properties—such as flashing and roughness—are minimized or eliminated to avoid damaging (i.e., scratching or deteriorating) the bottom of flexible container 102 during operation.

In yet another embodiment, an outer surface 202 of stir bar 106 may be smoothed to the point where it is possible to use stir bar 106 without the use of sheath 200. This is accomplished by polishing, tumbling, or other methods as would be appreciated by those skilled in the art.

### Stand

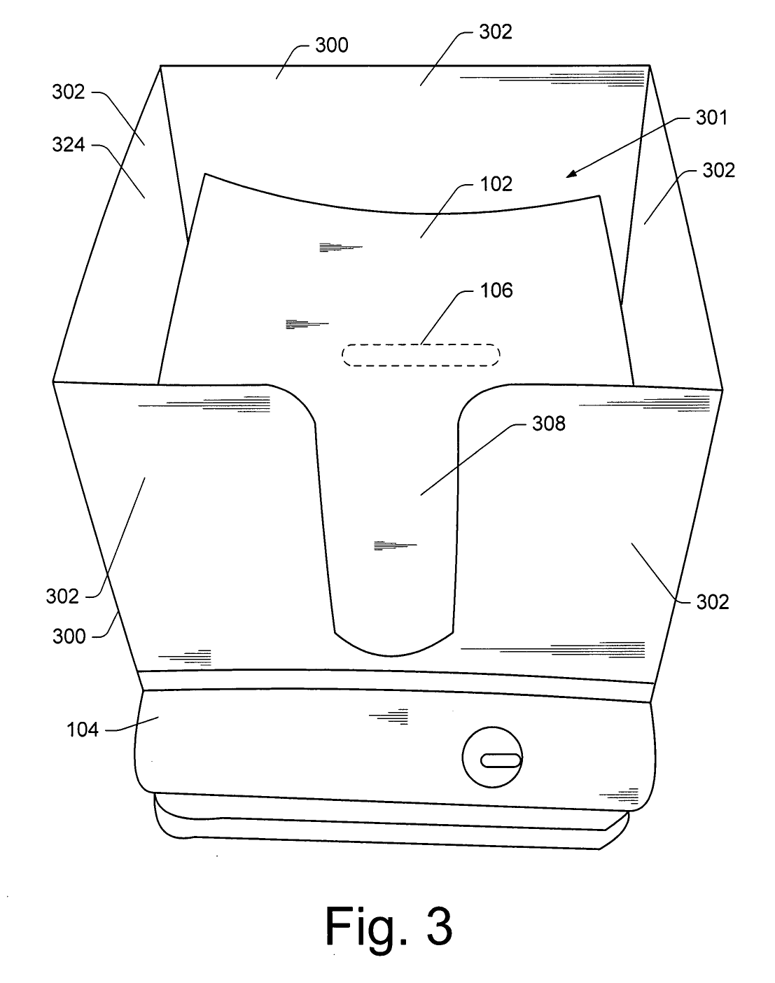

FIG. 3 shows another embodiment of a mixing system 100 which includes a stand 300. In particular, FIG. 3 shows a perspective view of system 100. Stand 300 permits flexible containers 102 that are of a larger volume, to be placed on magnetic mixer 104, and remain stationary and supported when filled with liquid.

As depicted in FIG. 3, stand 300 straddles magnetic mixer 104. Stand 300 may include four side walls 302 forming an interior compartment 301. Generally, walls 302 of stand 300 are coextensive with outer-peripheral edges 150 (see FIG. 1A) of top surface 108 of magnetic mixer 104. Thus, stand 300 serves as a frame supporting a flexible container 102 when placed on top of magnetic mixer 104.

It is pointed out that the stand may be implemented with support structures other than walls, such as poles, rods, wires, and other structures, as would be appreciated by those skilled in the art having the benefit of this disclosure. Additionally, the stand does not necessarily have to straddle the mixer system, and may include less than four walls.

Stand 300 may be removable and separate from magnetic mixer 104, with a bottom (not shown) configured to rest upon a ground surface, or any other surface structure, such as the same surface as mixer 104.

Alternatively, stand 300 may be physically connected to magnetic mixer 104, or attached thereto (removable or permanently) by some fastening mechanisms, such as clips, slide/track systems, brackets, welds, or by other suitable fastening mechanisms as would be readily appreciated by those skilled in the art.

Stand 300 may be composed of a variety of suitable materials such as metal, fiberglass, plastic, and composites, as would be appreciated by those skilled in the art.

In one embodiment, the top of stand 300 may also have on or more opening(s) 324 permitting hosing and tubing to connect to container 102 located within compartment 301. Stand 300 may also include a cutout 308 to allow a tubular hose (not shown) to connect directly to the sides of flexible container 102. Opening 324 is square shaped, and cutout 308 is U-shaped. But other quantities and different types of openings/cutouts, including different shapes, sizes, and configurations could be incorporated in stand 300 as would be appreciated by those skilled in the art after having the benefit of this disclosure.

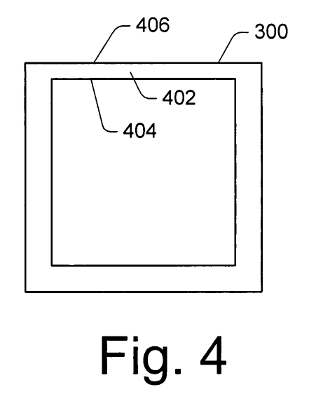

FIG. 4 shows a top view of stand 300 according to another embodiment of stand 300. This embodiment includes the addition of a chamber 402 formed between an inner wall 404 and outer wall 406 of stand 300. As depicted in FIG. 4, chamber 402 provides a gap between inner wall 404 and outer wall 406 in which fluid may be circulated as an external source to regulate the temperature of a solution in container 102 (FIG. 1), such as to heat or cool the solution in container 102. In another embodiments, heating or cooling elements (not shown), such as electric coils or piping, may be included within chamber 402 to heat or cool side walls 302, as would be appreciated by those skilled in the art.

### Turbulence

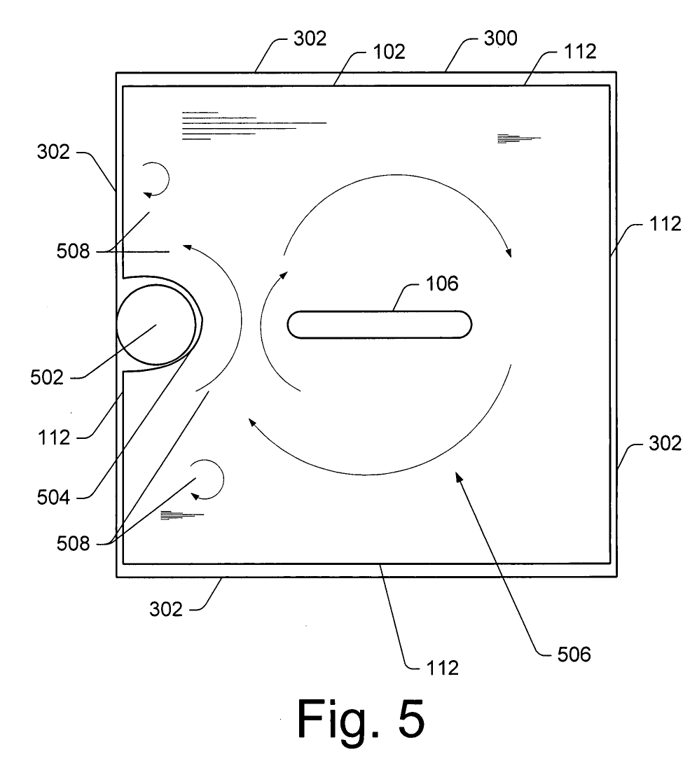

FIG. 5 shows a top view of stand 300, with a baffle 502 interposed between container 102, and side walls 302. Baffle 502 may be an integrated feature of stand 300, an integrated and permanent feature of container 102, and/or an independent structure that is inserted or removed from between stand 300 and/or container 102. Baffle 502 causes container 102 to deform when filled with fluid, because flexible container 502 takes the shape of the stand, or any rigid structures it abuts. That is, baffle 502 contacts, and thereby deforms (indents) the flexible film membrane of container 102, when container 102 is filled with solution. So, when stir bar 106 spins and fluid circulates, baffle 502 causes fluid to circulate erratically around a protrusion 504 caused by baffle 502, and imparts turbulence when fluid mixes around it. This prevents backflow from occurring.

For example, as depicted in FIG. 5, representative current flow 506 of solution in container 102 when the solution is mixed by a stir bar 106. As depicted in FIG. 6, a center vortex occurs within container 102 when stir bar 106 rotates. To ensure that the vortex is not uniform, baffle 502 causes turbulence 508 as the solution flows past and around the indentation caused by baffle 502. That is, solution is compressed as it flows past baffle 502 causing turbulence 508.

In one embodiment, baffle 502 is implemented as a cylindrical rod that is interposed between sides 112 of flexible container 102, and walls 302 of stand 300. In other embodiments, baffle 502 may be implemented using other materials, and take any suitable form, shape, or configuration that is capable of contacting the side of container 102, and thereby deform the shape of one or more areas of the flexible film membrane of container 102, as would be appreciated by those skilled in the art. Further, more than one baffle 502 may be used to generate higher-desired levels of turbulence within container 102.

The shape of walls 302 could also have other physical structures that are permanent or selectively removable from between container 102 and walls 302. In still another embodiment, the shape of container 102 may be dynamically adjusted through the use of one or more structures that can selectively contact container during the mixing process, such as by one or more rods (not shown) that slide outwardly from walls 302 towards the interior of stand 300.

Still further, in another embodiment, one or more baffles 502 could be integrated, inserted, or attached as part of the interior or exterior of container 102 to create an uneven surface of the film material within the inside of container 102, thereby facilitating turbulence when fluids are mixed by stir bar 106.

In summary, solutions can be mixed using a flexible, and collapsible bag-like container that is placed directly on a top surface of a magnetic mixer. A stir bar may rest on a flat surface of the bottom of the container, and directly the thin flexible sheet comprising the container. As the stir bar is non-abrasive (smoothed or encapsulated in a soft material), the stir bar may rotate on the bottom flat surface of the container, without deteriorating or damaging the film sheet of the container. Solution may be mixed, and emptied without moving the container while on the magnetic mixer, via hoses and tubes attached to the container. Once mixing is complete, it is not necessary to clean the container, rather the container (i.e., the bag) can simply be discarded.

The embodiments described herein are to be considered in all respects only as exemplary and not restrictive. The scope of the invention is, therefore, indicated by the subjoined Claims rather by the foregoing description. All changes which come within the meaning and range of equivalency of the Claims are to be embraced within their scope.

What is claimed is:

1. An apparatus for use with magnetic mixer, comprising: a stand including a first set of support members that are generally coextensive with outer peripheral edges of a top surface of a mixing surface of the magnetic mixer, the support members are also generally perpendicular to a horizontal plane of the mixing surface; wherein the first set of support members form an internal compartment in which a flexible container is placed when resting on top of the magnetic mixer.

2. The apparatus as recited in claim 1, wherein the first set of support members are vertical walls that provide support to an exterior body of the flexible container when the flexible container is filled with solution.

3. The apparatus as recited in claim 1, wherein at least one of the first set of support members includes an opening in its side.

4. The apparatus as recited in claim 1, wherein the stand is comprised of at least one of a metal, plastic, and composite material.

5. The apparatus as recited in claim 1, wherein the top of stand includes an opening providing access to the internal compartment.

6. The apparatus as recited in claim 1, where the stand further comprises a second set of support members parallel to, and positioned a distance apart from the first set of support members, thereby forming a gap between the first and second set of support members.

7. The apparatus as recited in claim 1, wherein the stand further comprises a second set of support members parallel to, and positioned a distance apart from the first set of support members thereby forming a gap between the first and second set of support members, the gap providing a chamber in which to circulate and/or hold a liquid for controlling a temperature of the first and/or second set of vertical walls.

8. The apparatus as recited in claim 1, wherein the stand is configured to straddle the magnetic mixer.

9. An apparatus for use with magnetic mixer, comprising: a stand configured to straddle the magnetic mixer, the stand including four vertical walls that are coextensive with outer peripheral edges of a top surface of a mixing surface of the magnetic mixer, the four vertical walls are also perpendicular to a horizontal plane of the mixing surface; wherein the first set of four vertical walls form an internal compartment in which a flexible container is placed when resting on top of the magnetic mixer, whereby the first set of four vertical walls provide support to an exterior body of the flexible container when the flexible container is filled with solution; and
a baffle positioned on at least one of an external portion and internal portion of the bag.

10. The apparatus as recited in claim 9, wherein the baffle is interposed between an external surface of the flexible container, and an internal-side of at least one of the four vertical walls.

11. The apparatus as recited in claim 9, wherein the baffle is a structure configured to indent and/or deform a shape of the flexible container when the flexible container is filled with solution, and abuts at least one of the four vertical walls.

12. The apparatus as recited in claim 9, wherein the stand is comprised of at least one of a metal, plastic, and composite material.

13. The apparatus as recited in claim 9, wherein at least one of the four vertical walls includes an opening in its side.

14. The apparatus as recited in claim 9, wherein at least one of the four vertical walls is coupled to the magnetic mixer.

15. The apparatus as recited in claim 9, wherein the top of stand includes an opening providing access to the internal compartment.

16. A system, comprising:
a magnetic mixer;
a stand including a first set of four vertical walls that are coextensive with outer peripheral edges of a top surface of a mixing surface of the magnetic mixer, the first set of four vertical walls are also perpendicular to a horizontal plane of the mixing surface; wherein the first set of four vertical walls form an internal compartment in which a flexible container is placed when resting on top of the magnetic mixer.

17. The system as recited in claim 16, further comprising a structure member interposed between an external surface of the flexible container, and an internal-side of at least one of the four vertical walls, wherein the structure member is configured to indent and/or deform a shape of the flexible container when the flexible container is filled with solution, and abuts at least one of the four vertical walls.

18. The system as recited in claim 16, further comprising a second set of four vertical walls that are parallel to, and positioned a distance apart from the first set of four vertical walls thereby forming a gap between the first and second set of four vertical walls, the gap providing a chamber in which to circulate and/or hold a liquid for controlling a temperature of the first and/or second set of vertical walls.
